(19) United States
(12) Patent Application Publication
(10) Pub. No.: US 2026/0370941 A1
(43) Pub. Date: Nov. 19, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: MASATO NAKATA, Kanagawa (JP); TOMOHIRO NISHIYAMA, Tokyo (JP)

(21) Appl. No.: 19/630,973

(22) Filed: Mar. 27, 2026

(30) Foreign Application Priority Data
May 19, 2025 (JP) 2025-083605

(51) Int. Cl. H04N 23/68; H04N 23/695

(52) U.S. Cl. CPC H04N 23/6811; H04N 23/695

(57) ABSTRACT

In an image processing apparatus, a subject of interest to which attention should be paid is set from among subjects detected from an image, an appearance frequency distribution with respect to at least one of a position of the subject of interest and a velocity of the subject of interest is acquired, and responsiveness of automatic framing is controlled based on the appearance frequency distribution.

### BACKGROUND

### Field of the Technology

The present disclosure relates to an image processing apparatus, an image processing method, a storage medium, and the like.

### Description of the Related Art

In a system that captures and distributes sports competitions, live performances, and the like, the importance of technology that recognizes subjects of interest, plays, events, and the like and that automatically performs framing is increasing.

In Japanese Patent Application Laid-Open No. 2021-60701, technology related to automatic framing is disclosed, and a method that uses information related to a position of a subject and to the attributes of the subject, and realizes automatic framing is disclosed. In addition, in Japanese Patent Application Laid-Open No. 2005-223487, in a system that automatically performs capturing, editing, and distribution of sports competitions, a method that uses player information and ball information in captured video, and automatically generates video is disclosed.

However, in Japanese Patent Application Laid-Open No. 2021-60701, prior information called a production profile such as a subject of interest and an area of interest that are set in advance is used, and framing is performed, and further, it becomes necessary to acquire world coordinates of a subject. Accordingly, a large amount of information becomes necessary in advance with respect to subject features, camera installation positions, and capturing areas.

Furthermore, in Japanese Patent Application Laid-Open No. 2005-223487, since it is necessary to set field information and court information of a sports competition in advance, restrictions on camera installation positions arise. Specifically, in order to specify a position of a subject, and to acquire field information and court information of a competition, it is necessary to install a camera at a high location and to use an overhead view image from diagonally above.

In contrast, in view of acquiring powerful images and images having a sense of presence, and in view of convenience of camera installation, it is desirable that the camera be installable at a low location of about eye level. However, in a case in which the camera is installed at a low location, framing tends to become unstable due to a decrease in extraction accuracy of field information and court information compared to a case in which the camera is installed at a high location.

### SUMMARY

An image processing apparatus according to an embodiment of the present disclosure sets a subject of interest to which attention should be paid from among subjects detected from an image, acquires an appearance frequency distribution with respect to at least one of a position of the subject of interest and a velocity of the subject of interest, and controls responsiveness of automatic framing based on the appearance frequency distribution.

Further features of the present disclosure will become apparent from the following description of embodiments with reference to the attached drawings.

### BRIEF DESCRIPTION OF THE DRAWINGS

FIG. 1 is a system block diagram showing a configuration example of an image pickup apparatus 101 according to a First Embodiment of the present disclosure.

FIG. 2 is a functional block diagram showing a functional configuration example of the image pickup apparatus 101 according to the First Embodiment.

FIG. 3 is a flowchart showing a processing example of an image capturing method by the image pickup apparatus 101 according to the First Embodiment.

FIGS. 4A and 4B are diagrams for explaining a processing example of subject position and velocity setting in step S306.

FIG. 5 is a diagram in which detection region information set by the subject position and velocity setting processing of step S306 is superimposed and displayed as bounding rectangles, and velocity information is superimposed and displayed as arrows, on a captured image.

FIG. 6 is a flowchart showing a processing example of appearance frequency distribution setting in step S308.

FIGS. 7A and 7B are diagrams for explaining an example of a result concept of the appearance frequency distribution according to the First Embodiment.

FIG. 8 is a diagram for explaining an example of a temporal change in framing position according to the First Embodiment.

FIGS. 9A to 9C are diagrams for explaining an example of framing parameter setting according to the First Embodiment.

FIG. 10 is a diagram for explaining an example of framing parameter setting according to a Second Embodiment.

FIG. 11 is a diagram for explaining an example of a framing sensitivity coefficient using statistical quantities according to a Fourth Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

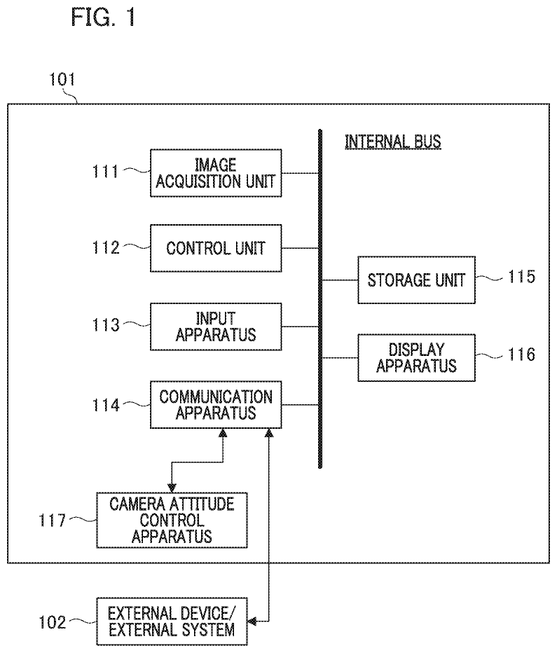

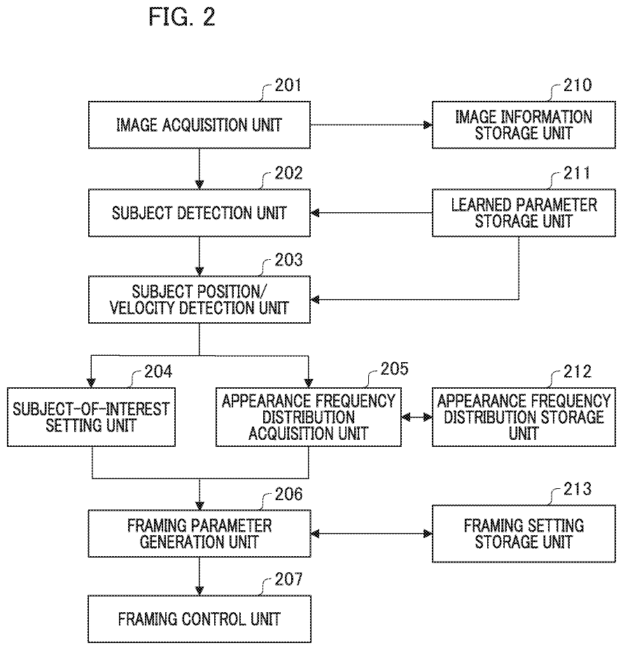

With reference to FIG. 1 and FIG. 2, a system configuration according to a First Embodiment of the present disclosure, and data and a processing flow related to the embodiment of the present disclosure are explained.

FIG. 1 is a system block diagram showing a configuration example of an image pickup apparatus 101 according to the First Embodiment of the present disclosure. In FIG. 1, the image pickup apparatus 101 is provided with an image acquisition unit 111, a control unit 112, an input apparatus 113, a communication apparatus 114, a storage unit 115, a display apparatus 116, and a camera attitude control apparatus 117. It should be noted that the image pickup apparatus 101 functions as an image processing apparatus.

The image acquisition unit 111 is an image sensor such as a CCD (Charge-Coupled Device), a MOS (Metal-Oxide-Semiconductor), a CMOS (Complementary Metal-Oxide-Semiconductor), and the like.

The control unit 112 has a CPU and the like built therein as a computer, and functions as a control unit configured to control operation of each unit of the entire apparatus based on a computer program stored in a memory as a storage medium.

That is, the control unit 112 has, for example, a CPU (Central Processing Unit), a GPU (Graphics Processing Unit), and an FPGA (Field Programmable Gate Array) built therein.

The input apparatus 113 includes a keyboard and a mouse for operating the image pickup apparatus, and a touch panel and the like of the display apparatus 116 described below.

The communication apparatus 114 is an interface for performing information exchange with external devices. The communication apparatus 114 is Ethernet, MIPI, I2C, SPI, HDMI (registered trademark), USB, and the like.

It should be noted that MIPI is an abbreviation for Mobile Industry Processor Interface, and I2C is an abbreviation for Inter-Integrated Circuit. In addition, SPI is an abbreviation for Serial Peripheral Interface, HDMI is an abbreviation for High-Definition Multimedia Interface, and USB is an abbreviation for Universal Serial Bus.

The storage unit 115 is a ROM (Read Only Memory), a RAM (Random Access Memory), an HDD (Hard Disk Drive), an SSD (Solid State Drive), and the like.

The storage unit 115 stores a computer program for operating the image pickup apparatus, a computer program for performing capturing by the control unit, input/output data, various parameters for apparatus operation, capturing data, and the like. The display apparatus 116 is an output device for operating the image pickup apparatus and for drawing input/output data, and may be provided with an LCD (Liquid Crystal Display) and the like.

The camera attitude control apparatus 117 includes at least one of, for example, a pan mechanism, a tilt mechanism, an optical zoom mechanism, and the like, for controlling and for changing camera attitude and angle of view. An external device/external system 102 is a device such as a workstation or a server for the purpose of recording, processing, utilizing, distributing, and the like of images captured by the image pickup apparatus 101, and an external sensor device such as an IMU or a GNSS, and the like. It should be noted that the configuration illustrated in FIG. 1 is merely an example of a system configuration, and the configuration is not limited thereto.

FIG. 2 is a functional block diagram showing a functional configuration example of the image pickup apparatus 101 according to the First Embodiment. It should be noted that some of the functional blocks illustrated in FIG. 2 are realized by causing a CPU and the like serving as a computer (not shown) included in the control unit 112 of the image pickup apparatus 101 to execute a computer program stored in the storage unit as a storage medium.

However, some or all of the functional blocks may be realized by hardware. As the hardware, a dedicated circuit (ASIC), a processor (reconfigurable processor, DSP), and the like can be used.

In addition, the respective functional blocks illustrated in FIG. 2 do not need to be built into the same housing, and may be configured by separate apparatuses connected to each other via signal paths. Additionally, the image processing apparatus of the present embodiment may be an apparatus separate from a camera, and may be realized by an information processing apparatus such as a PC and the like.

With reference to FIG. 2, functions, processing, and the like related to the image pickup apparatus 101 are explained. The image pickup apparatus 101 includes an image acquisition unit 201, a subject detection unit 202, a subject position/velocity detection unit 203, a subject-of-interest setting unit 204, an appearance frequency distribution acquisition unit 205, a framing parameter generation unit 206, and a framing control unit 207.

In addition, the image pickup apparatus 101 is provided with an image information storage unit 210, a learned parameter storage unit 211, an appearance frequency distribution storage unit 212, and a framing setting storage unit 213.

The image acquisition unit 201 acquires image information from the image acquisition unit 111, and stores the image information in the image information storage unit 210. The image information is a color image, a monochrome image, and the like, and the data format is a still image or a moving image.

The subject detection unit 202 acquires a subject detection parameter from the learned parameter storage unit 211 of the storage unit 115, and detects a subject. The subject is a person, an object, and the like, and for the subject detection, a technique such as a CNN (Convolutional Neural Network) model-based technique may be used.

The subject position/velocity detection unit 203 calculates a position of a subject detected by the subject detection unit 202 and a velocity of the subject detected by the subject detection unit 202. Although the position of the subject and the velocity of the subject are two-dimensional information based on image coordinates, three-dimensional information may also be used in a case in which a three-dimensional position of the subject can be specified.

The subject-of-interest setting unit 204 selects and sets a subject of interest to which attention should be paid from among subjects detected from an image. It should be noted that the subject-of-interest setting unit 204 may be any unit configured to set a position of the subject of interest in a two-dimensional space or in a three-dimensional space.

The appearance frequency distribution acquisition unit 205 sets an appearance frequency distribution representing a subject appearance probability with respect to a position of a subject and a velocity of the subject, and stores the result thereof in the appearance frequency distribution storage unit 212. It should be noted that the appearance frequency distribution acquisition unit 205 may be any unit configured to acquire an appearance frequency distribution with respect to at least one of a position of the subject of interest and a velocity of the subject of interest.

The appearance frequency distribution may be expressed as a parameter of a function determined in advance for a position and a velocity, or may be expressed as a discrete frequency distribution for the position and the velocity. For the position and for the velocity, two-dimensional information or three-dimensional information is used, similarly to subject position and subject velocity.

The framing parameter generation unit 206 reads out setting values related to framing from the framing setting storage unit 213. Then, the framing parameter generation unit 206 uses the subject-of-interest information set by the subject-of-interest setting unit 204 and the appearance frequency distribution set by the appearance frequency distribution acquisition unit 205, and sets parameters for framing.

In a case in which framing is realized by changing camera attitude, the parameters for framing may be target values of a pitch angle, a yaw angle, and a roll angle, parameters related to velocity of change, and the like, wherein the pitch angle, the yaw angle, and the roll angle are camera attitude information.

In addition, in a case in which framing is realized by cropping from an image, the parameters may be a target value of a position of a crop region and a target value of a size of the crop region, parameters related to a velocity of change, and the like. It should be noted that the parameters for framing in the present embodiment include, in particular, responsiveness of automatic framing.

Furthermore, a control model for framing operation may be set, and parameters of the control model may be set. For example, the control model may be a Voigt model in which a spring and a dashpot are connected in parallel, and a spring constant and a viscosity may be set as parameters.

In a case in which the framing control unit 207 changes camera attitude, the framing control unit 207 transmits a target attitude of the camera, an attitude change velocity, a control time constant to the target attitude, and the like via the communication apparatus 114, and controls camera attitude using the camera attitude control apparatus 117.

In contrast, in a case in which the framing control unit 207 performs crop processing from an image, crop processing is performed by the control unit 112, and the crop-processed image is stored in the storage unit 115, displayed on the display apparatus 116, and transmitted to the external device/external system 102 via the communication apparatus 114.

In this manner, the framing control unit may be any unit configured to control at least one of an attitude change of an image capturing apparatus for acquiring an image, optical zooming of the image capturing apparatus, and a cutout range of an image (crop range) of the image capturing apparatus. It should be noted that the framing control unit 207 controls at least responsiveness (including velocity) of automatic framing based on the appearance frequency distribution.

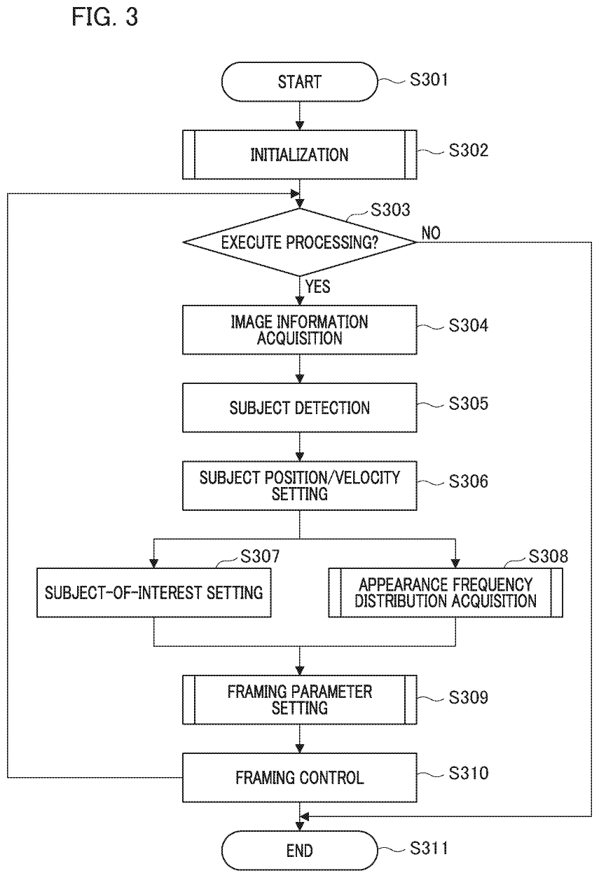

FIG. 3 is a flowchart showing a processing example of an image capturing method by the image pickup apparatus 101 according to the First Embodiment. It should be noted that operation of each step of the flowchart of FIG. 3 is sequentially performed by the CPU and the like serving as a computer in the control unit 112 executing a computer program stored in the storage unit 115.

Step S301 in FIG. 3 is a step of loading a computer program stored in advance in the storage unit 115, and starting a processing program. In step S302, initialization is performed. That is, parameters for program operation are loaded from the storage unit 115, or are set via the input apparatus 113 and the like.

In step S303, a determination is made as to whether or not to continue execution of processing. Step S304 is a step of acquiring image information acquired by the image acquisition unit 201 and stored in the image information storage unit 210.

Step S305 is a step of detecting a subject from an image acquired by the image acquisition unit 201. Step S306 is a step of setting a position and a velocity of a subject detected in step S305. Step S307 functions as a subject-of-interest setting step, and sets a subject of interest to which attention should be paid from among subjects detected from an image in step S305.

Step S308 is a step of using the subject position and velocity set in step S306, and acquiring an appearance frequency distribution related to the position and the velocity. In this context, step S308 functions as an appearance frequency distribution acquisition step of acquiring an appearance frequency distribution with respect to at least one of a position of the subject of interest and a velocity of the subject of interest.

Step S309 is a step in which the subject of interest set in step S307 and the appearance frequency distribution acquired in step S308 are used, and framing parameters are set.

Step S310 is a step of performing framing control based on the framing parameters set in step S309. Step S311 is a step of ending the processing. In this context, step S309 and step S310 function as a framing control step of controlling responsiveness (including velocity) of automatic framing based on the appearance frequency distribution. It should be noted that the processing flow of FIG. 3 is periodically and repeatedly performed, for example, in N-frame period units (N is an integer equal to or greater than 1).

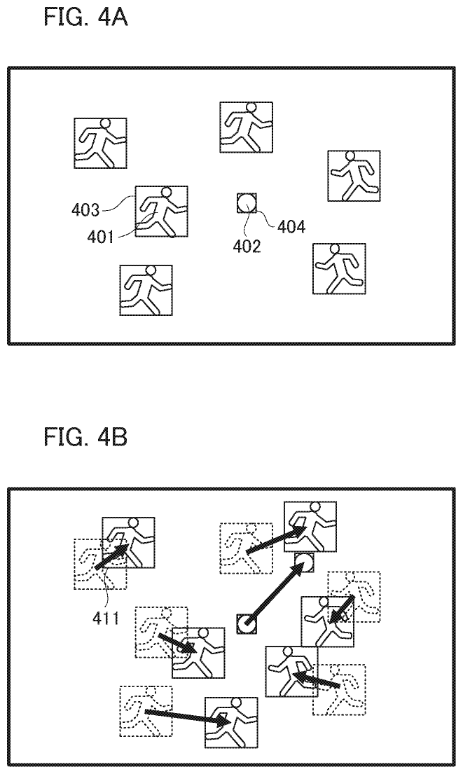

FIGS. 4A and 4B are diagrams for explaining a processing example of subject position/velocity setting in step S306. In FIG. 4, a sports competition is assumed to be captured, and particularly, a competition using a ball as equipment is assumed, and an example in which a plurality of persons and a ball are present is explained.

FIG. 4A illustrates an example of an image captured at time t. FIG. 4B illustrates an example of an image captured at time t+Δt, that is, a time after elapse of Δt from FIG. 4A. In FIG. 4A, 401 indicates a person, 402 indicates a ball, 403 indicates a person region detected by step S305 for subject detection, and 404 indicates a ball region.

It should be noted that in FIG. 4B as well, a person region and a ball region are assumed to be detected in a manner similar to the detection in FIG. 4A. After association is performed for the person region and the ball region between time t illustrated in FIG. 4A and time t+Δt illustrated in FIG. 4B, a position movement amount of the person region indicated at 411 in FIG. 4B and a position movement amount of the ball region are each obtained, and respective subject velocities are set by dividing the position movement amounts by the elapsed time Δt.

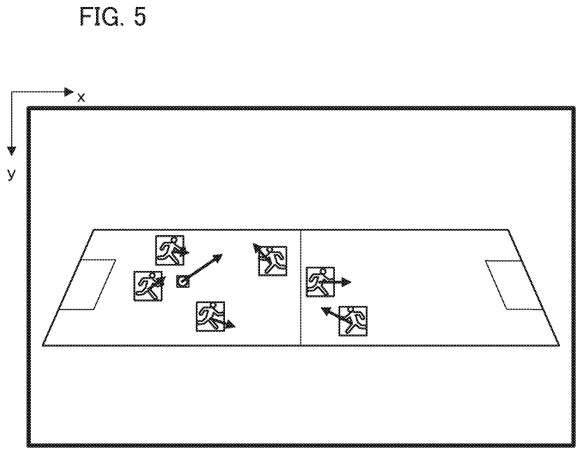

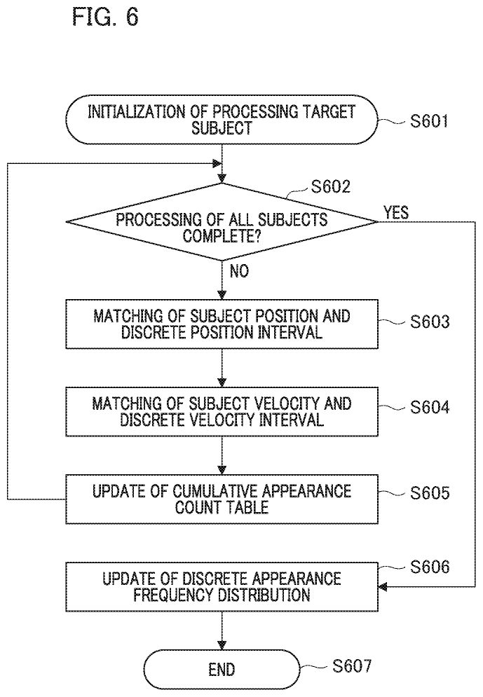

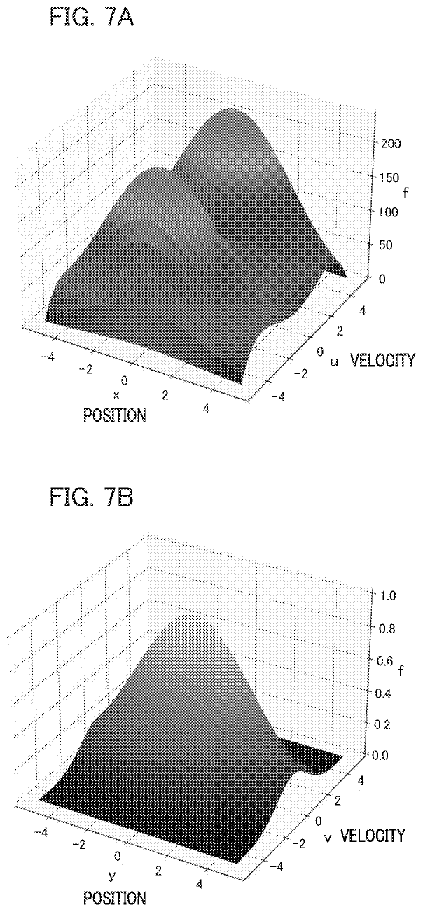

Next, with reference to FIG. 5, FIG. 6, and FIG. 7, processing of appearance frequency distribution setting is explained. Similarly to FIG. 4, an example in which a sports scene using a ball as equipment is a capturing target is explained.

FIG. 5 is a diagram in which detection region information set by the subject position and velocity setting processing of step S306 is superimposed and displayed as bounding rectangles, and velocity information is superimposed and displayed as arrows, on a captured image.

FIG. 6 is a flowchart showing a processing example of appearance frequency distribution setting in step S308. It should be noted that operation of each step of the flowchart of FIG. 6 is sequentially performed by the CPU and the like serving as a computer in the control unit 112 executing a computer program stored in the storage unit 115.

FIGS. 7A and 7B are diagrams for explaining an example of a result concept of the appearance frequency distribution according to the First Embodiment. It is assumed that positions and velocities of persons and the ball are defined in the two-dimensional coordinate system (x, y) illustrated in FIG. 5. It should be noted that a coordinate origin is assumed to be at the center of an angle of view.

In the present embodiment, as illustrated in FIG. 5, a court and an entire field of a sport are acquired as an image at a wide angle, and the frequency at which a person and a ball are detected becomes high near the center in the y direction within the angle of view.

The appearance frequency distribution can be expressed as ƒ(x, y, u, v) as a function of position and velocity, where u is velocity in the x direction, and vis velocity in the y direction. It should be noted that in the image pickup apparatus 101 of the present embodiment, it is assumed that a discrete frequency distribution is acquired as the appearance frequency distribution, and a method for acquiring a discrete appearance frequency distribution is explained.

A position range and a velocity range that a subject can take are determined, and a discrete position range and a discrete velocity range are generated by dividing each of the position range and the velocity range into finite intervals. In this context, the position range is divided into nₓ in the x direction and into n_{y} in the y direction, and the velocity range is divided into mₓ in the x direction and into m_{y} in the y direction.

In addition, the number of times a subject has appeared is accumulated from the start of operation of the image pickup apparatus, and it is assumed that a table of cumulative appearance count A that stores the accumulated number of times is maintained. The cumulative appearance count table is a table having a number of elements of nₓ×n_{y}×mₓ×m_{y}, and it is assumed that the cumulative appearance count of a discrete position interval (ix, iy) and a discrete velocity interval (iu, iv) is expressed as A(ix, iy, iu, iv).

In addition, the appearance frequency distribution is expressed as F, and a discrete appearance frequency distribution of a discrete position interval (ix, iy) and a discrete velocity interval (iu, iv) is expressed as F(ix, iy, iu, iv). In this context, it is assumed that persons and the ball, wherein persons and the ball are subjects, exist in a total of n, and it is assumed that a position of a certain subject i is expressed as (xᵢ, yᵢ), and a velocity of the subject i is expressed as (uᵢ, vᵢ).

With reference to FIG. 6, a processing example of appearance frequency distribution setting in step S308 is explained. In step S601, initialization of a processing target subject is performed. In step S602, a determination is made as to whether or not processing of all subjects is complete.

In step S603, matching between a subject position and a discrete position interval is performed. That is, the position (xᵢ, yᵢ) of subject i is matched with a discrete position interval. Then, a discrete position interval (ix, iy) that includes the position of subject i is specified.

In step S604, matching between a subject velocity and a discrete velocity interval is performed. That is, the velocity (uᵢ, vᵢ) of subject i is matched with a discrete velocity interval. Then, a discrete velocity interval (iu, iv) that includes the velocity of subject i is specified.

In step S605, the cumulative appearance count table is updated. That is, 1 is added to an element of the cumulative appearance count A(ix, iy, iu, iv) corresponding to the discrete position interval matched in step S603 and to the discrete velocity interval matched in step S604. In step S606, the discrete appearance frequency distribution F is updated. In this context, the discrete appearance frequency distribution F can be obtained by the following Equation (1).

$$F ( ix , iy , iu , i v ) = \frac{A ( ix , iy , iu , iv )}{{\sum }_{ix = 1}^{{N}_{x}} {\sum }_{iy = 1}^{{n}_{y}} {\sum }_{iu = 1}^{{m}_{x}} {\prod }_{i v = 1}^{{m}_{y}} A ( ix , iy , iu , iv )} \qquad ( 1 )$$

In step S607, processing of appearance frequency distribution acquisition is ended. In the present embodiment, a method is shown in which the appearance frequency distribution is updated after updating the cumulative appearance count table by sequential processing related to subject i. However, the cumulative appearance count table need not be maintained, and a value of a sum total of cumulative appearance counts may be maintained, and only the location of F(ix, iy, iu, iv) may be updated.

In FIGS. 7A and 7B, a result conceptual diagram of the appearance frequency distribution is shown. Although the appearance frequency distribution is a function or distribution related to position and velocity, for explanation, FIGS. 7A and 7B illustrate examples of distribution functions for each of the x direction and the y direction that are axial directions of space. FIG. 7A is a distribution function related to the x direction, and illustrates an appearance frequency distribution related to (x, u), and FIG. 7B is a distribution function related to the y direction, and illustrates an appearance frequency distribution related to (y, v).

With respect to the x direction, in a sport in which there are many scenes in which velocity of a subject is high near the center of an angle of view and the subject moves left and right in the x direction, a bimodal frequency distribution in a velocity direction as illustrated in FIG. 7A is obtained. In addition, with respect to the y direction, a subject often appears near the center, and in a case in which change in position and velocity of a subject in the y direction is small, a frequency distribution as illustrated in FIG. 7B is obtained.

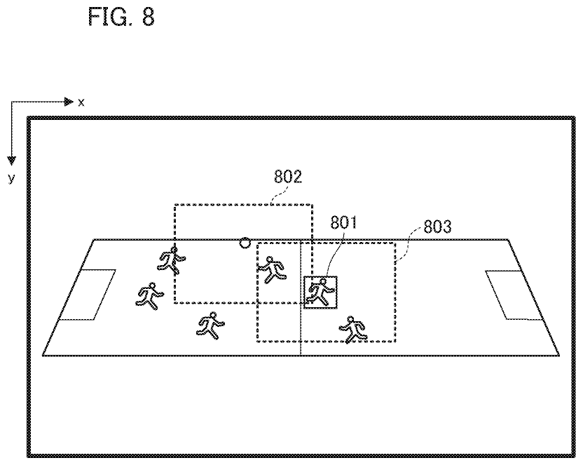

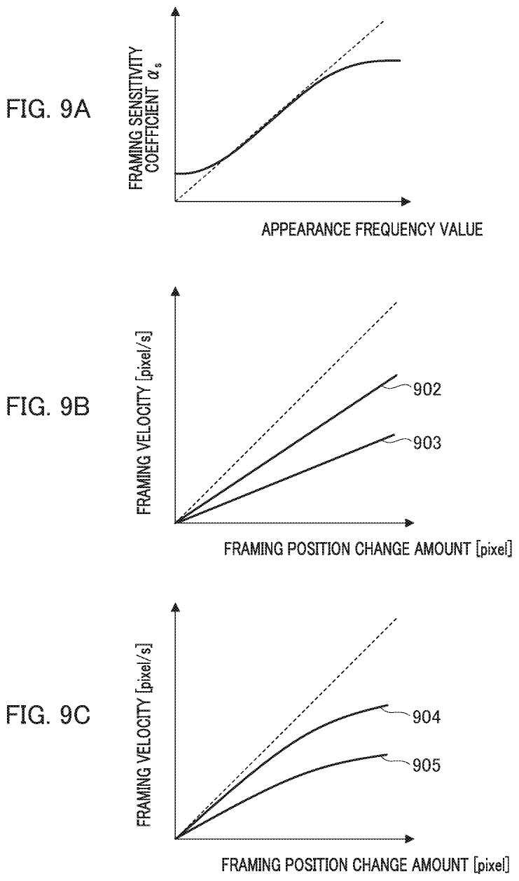

Next, with reference to FIG. 8 and FIG. 9, processing of framing parameter setting in step S309 is explained. FIG. 8 is a diagram for explaining an example of temporal change in framing position according to the First Embodiment.

FIGS. 9A to 9C are diagrams for explaining an example of framing parameter setting according to the First Embodiment. It should be noted that a framing parameter is a variable related to framing control, and includes a framing velocity, a parameter related to framing acceleration/deceleration, a parameter related to a control model for framing operation, and the like.

Reference numeral 801 in FIG. 8 is a subject of interest set by the subject-of-interest setting processing of step S307. Reference numeral 802 in FIG. 8 is a current framing position at a current time t, and 803 is a target framing position at time t+Δt centered on the subject of interest 801. It should be noted that Δt is an update period of the framing position.

In this context, framing from 802 to 803 in FIG. 8 within a time of Δt is framing having the highest responsiveness, and a framing velocity at this time is defined as a maximum framing velocity v_{ƒ,max}.

However, in a case in which a framing amount is large, framing at the maximum framing velocity impairs quality as an image, and thus in the present embodiment, it is assumed that a framing sensitivity coefficient as smaller than 1 is multiplied by the maximum framing velocity, and the framing velocity is relaxed.

It should be noted that this framing sensitivity coefficient as may be determined by using appearance frequency distribution information of the target framing position. Specifically, in a case in which a position and a velocity of the subject of interest are a high-frequency condition in light of the appearance frequency distribution, a setting may be made to increase the framing sensitivity coefficient as so as to increase tracking capability of framing.

Conversely, in a case in which a ball is positioned at an upper part of the angle of view of FIG. 8 and is set as a subject of interest, the target framing position (ball) becomes a condition in which the appearance frequency value is low. Accordingly, in that case, framing velocity can be relaxed by lowering the framing sensitivity coefficient as so as not to follow the ball excessively, and framing that maintains image quality can be realized.

It should be noted that in the present embodiment, since framing is performed based on an appearance frequency value of a subject, it is not necessary to extract information such as a field or a court from an image, and restrictions on installation position of a camera such as installing at a high location are small, and convenience is high.

Hereinafter, a specific processing example in the image pickup apparatus of the present embodiment is explained. Based on a position and a velocity of the subject of interest at 801 in FIG. 8, a discrete position interval (jₓ, j_{y}) and a discrete velocity interval (jᵤ, jᵥ) are specified, and by referring to the discrete appearance frequency distribution F(ix, iy, iu, iv), an appearance frequency value Fₐ of a position and velocity condition of the subject of interest is acquired.

In FIGS. 9A to 9C, setting examples of framing parameters are shown. FIG. 9A is a diagram showing a relationship of the framing sensitivity coefficient as with respect to an appearance frequency value. As the appearance frequency value becomes larger, the framing sensitivity coefficient tends to become larger.

In the image pickup apparatus 101 of the present embodiment, table data related to an appearance frequency value and a framing sensitivity coefficient illustrated in FIG. 9A is maintained in the framing setting storage unit 213. Then, from the above-described table data, search for a setting value closest to a discrete appearance frequency value Fₜ, interpolation processing, and the like are performed, and the framing sensitivity coefficient αₛ is calculated.

For the framing velocity v_{ƒ}, the above-described maximum framing velocity v_{ƒ,max} and the framing sensitivity coefficient αₛ are used, and the framing velocity v_{ƒ} can be set by Equation 2 below.

v_{ƒ}=v_{ƒ,max}αₛ (2)

In FIG. 9B, a difference in the relationship between a framing position change amount and a framing velocity due to a difference in framing sensitivity coefficient is shown. If the framing position change amount Δp_{ƒ} is defined as a difference between the target framing position and the current framing position, as Δp_{ƒ} becomes larger, a larger framing velocity becomes necessary. A dashed line in FIG. 9B represents a case in which the framing velocity becomes the maximum framing velocity.

In FIG. 9B, when the framing sensitivity coefficient αₛ is large, 902 results, and when the framing sensitivity coefficient αₛ is small, 903 results. It should be noted that, although there is a concern that image quality degrades due to the framing velocity becoming excessive in a case in which there is a large framing position change, in the present embodiment, the framing velocity is made dependent on the framing position change amount Δp_{ƒ}.

Thereby, framing that does not impair image quality can be realized. That is, in the present embodiment, for example, the framing velocity v_{ƒ} is set by Equation (3) below.

v_{ƒ}=v_{ƒ,max}αₛ/\sqrt{Δp_{ƒ}} (3)

In FIG. 9C, a difference in the relationship between a target position change amount and a framing velocity due to a difference in framing sensitivity coefficient is shown. In FIG. 9C, when the framing sensitivity coefficient αₛ is large, 904 results, and when the framing sensitivity coefficient αₛ is small, 905 results.

In addition, as illustrated in FIG. 9C, change in framing velocity relative to an increase in framing position change amount Δp_{ƒ} is made small. It should be noted that the setting method of the framing velocity is not limited to the above-described Equation (3). Framing parameters generated in step S309 are saved in the storage unit 115, and are used in framing control processing in step S310.

That is, in the framing control processing of step S310, when changing the attitude of the camera, motor control is performed for changing attitude toward a target attitude of the camera based on framing parameters such as the above-described framing velocity. In addition, in a case in which framing is controlled by cutting out from an image, cutout processing may be performed based on the framing parameters.

In this manner, in the present embodiment, framing is performed based on a capturing history from after activation of the image pickup apparatus and based on a frequency distribution of a position of a subject and of a velocity of the subject. It should be noted that the appearance frequency distribution acquisition unit may be any unit configured to acquire an appearance frequency distribution based on a history of at least one of a position of a subject and a velocity of a subject. By configuring in this manner, capturing by stable automatic framing becomes possible. It should be noted that, when the image pickup apparatus is powered on, the appearance frequency distribution from the previous capturing time may be inherited, and framing may be performed.

In that case, data stored in the appearance frequency distribution storage unit 212 is saved to a non-volatile memory in the storage unit 115 or to the external device/external system 102 via the communication apparatus 114, periodically or when power of the image pickup apparatus is turned OFF. Then, the above-described saved data may be read at the time of activation of next capturing.

Additionally, even when there is a change in installation position by a user, it is possible for the image pickup apparatus to address the change by transforming the appearance frequency distribution. That is, for example, a change amount in position and attitude of the camera is detected by an external sensor device such as an IMU (Inertial Measurement Unit) that is the external device/external system 102. Then, after obtaining a transformation matrix before and after a change in position and attitude of the camera, the appearance frequency distribution is transformed to a coordinate system at a new camera position and attitude.

That is, by the framing control unit performing processing of transforming the appearance frequency distribution in accordance with the change in position and attitude in a case in which a change in position and attitude of an image capturing apparatus for acquiring an image is detected, appropriate automatic framing can be realized even if position and attitude of the camera are changed.

In addition, in the present embodiment, the appearance frequency distribution is handled in a two-dimensional space. However, it is also possible to handle the appearance frequency distribution in a three-dimensional space by image processing or by a ranging device such as GNSS or LiDAR that is the external device/external system 102.

It should be noted that GNSS is an abbreviation for Global Navigation Satellite System, and LiDAR is an abbreviation for Light Detection And Ranging.

In that case, handling becomes possible by extending from an appearance frequency distribution ƒ(x, y, u, v) in a two-dimensional space to an appearance frequency distribution ƒ(x, y, z, u, v, w) in a three-dimensional space by newly adding a position z and a velocity w in the z-axis direction.

### Second Embodiment

In a Second Embodiment, an appearance frequency distribution is held for each of the coordinate axis directions that are mutually orthogonal in a two-dimensional space or a three-dimensional space. That is, the appearance frequency distribution acquisition unit of the Second Embodiment sets an appearance frequency distribution based on a history of the position of a subject and a history of the velocity of the subject for each of the coordinate axis directions that are mutually orthogonal in a two-dimensional space or a three-dimensional space. Thereby, memory consumption and the amount of computation can be reduced.

The discrete appearance frequency distribution shown in the First Embodiment is a table having a number of elements of nₓ×n_{y}×mₓ×m_{y}, the memory capacity for storage of the table is also large, and the processing cost required for referencing table values is also high. In addition, in a case in which the appearance frequency distribution is held as three-dimensional information, processing memory and an amount of computation become even larger.

In contrast, for example, in a case in which two-dimensional coordinate axes are set as in FIG. 8, the position and the velocity of a subject have low correlation between the x direction and the y direction, and it is possible to treat the x direction and the y direction separately, and an appearance frequency distribution is preferably held for each coordinate axis direction. Specifically, it suffices to hold a discrete appearance frequency distribution Fₓ(ix, iu) corresponding to an appearance frequency distribution fx(x, u) for the x direction, and a discrete appearance frequency distribution F_{y}(iy, iv) corresponding to an appearance frequency distribution fy(y, v) for the y direction.

In the Second Embodiment, a discrete position interval (ix, iy) and a discrete velocity interval (iu, iv) are identified based on the position and the velocity of the subject 801 in FIG. 8, and by referring to the discrete appearance frequency distribution Fₓ(ix, iu) and the discrete appearance frequency distribution F_{y}(iy, iv), a discrete appearance frequency value Fₜ,x and a discrete appearance frequency value Fₜ,y are acquired.

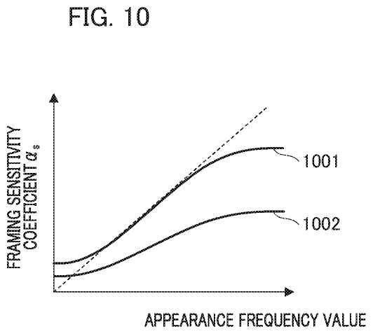

Thereafter, similarly to the First Embodiment, the framing sensitivity coefficient is set. Similarly to the First Embodiment, although a single parameter representing a relationship of the framing sensitivity coefficient to the appearance frequency value may be used, in the Second Embodiment, an example in which framing sensitivity to the appearance frequency value is separately set for each of the x direction and the y direction is explained by using FIG. 10.

FIG. 10 is a diagram for explaining an example of framing parameter setting in the Second Embodiment, and shows an example of a relationship of the framing sensitivity coefficient to the appearance frequency value. Reference numeral 1001 shows an example of a response function to the appearance frequency value in the x direction, and reference numeral 1002 shows an example of a response function to the appearance frequency value in the y direction.

In this manner, by setting the response function to the appearance frequency value in the x direction and the response function to the appearance frequency value in the y direction, framing toward a specific direction (the y direction) can be suppressed in a sports scene as in FIG. 8. In addition, in a case in which characteristics of the capturing scene can be grasped in advance and the like, the response function can be optimized.

### Third Embodiment

In a Third Embodiment, when the appearance frequency distribution obtained in the appearance frequency distribution setting processing of step S308 is used for the framing parameter setting of step S309, filtering processing for smoothing is included.

That is, in the Third Embodiment, the framing control unit performs filtering processing for smoothing the appearance frequency distribution obtained by the appearance frequency distribution acquisition unit. Thereby, in a case in which there is a rapid change in the frequency distribution, or in a case in which history data is insufficient, stability of framing is realized.

In the First Embodiment and the Second Embodiment, in step S606, the discrete appearance frequency distribution is updated based on subject position and velocity information. For this reason, in a case in which the number of updates immediately after startup of the image pickup apparatus is small and the like, since history data is not sufficiently accumulated, there is a possibility that variation attributable to data insufficiency occurs in the appearance frequency distribution.

When a discrete appearance frequency distribution having such variation is used, and framing parameter setting processing is performed at step S309, there is a possibility that stability of framing is impaired.

In contrast, in the Third Embodiment, even in such a case, by performing smoothing processing, stability can be improved. That is, in the Third Embodiment, a smoothing filter function h(x, y, u, v) is applied to an appearance frequency distribution ƒ(x, y, u, v), and an appearance frequency distribution ƒₛ(x, y, u, v) after smoothing is acquired by using the following Equation (4).

ƒₛ(x,y,u,v)=h(x,y,u,v)=ƒ(x,y,u,v) (4)

However, the operator * in Equation (4) is a convolution operation. The smoothing filter function may be a function having low-pass filter characteristics that block high-frequency components. In addition, the intensity of smoothing may be optimized based on the position and on the velocity.

By performing such smoothing, in a sports scene and the like, detailed setting for each area, such as whether to prioritize tracking capability for the subject or to prioritize stability of framing, becomes possible.

For this purpose, in the image pickup apparatus 101 of the Third Embodiment, the appearance frequency distribution and the smoothing filter are each held as discrete tables. Then, when the convolution operation of Equation (4) is performed, the discrete appearance frequency distribution and the discrete smoothing filter are converted to a frequency space, and by performing inverse conversion to the original space after the operation, efficient computation can be performed.

Although the appearance frequency distribution in the First Embodiment was explained as an example in the above-described explanation, a smoothing filter may also be applied to the appearance frequency distribution for each spatial axis as in the Second Embodiment. The discrete appearance frequency distribution Fs(ix, iy, iu, iv) after smoothing may be stored in the appearance frequency distribution storage unit 212.

It should be noted that, although in the First Embodiment, the discrete appearance frequency distribution F(ix, iy, iu, iv) was referred to in order to obtain the appearance frequency value Fₐ, in the Third Embodiment, it suffices to refer to the discrete appearance frequency distribution Fs(ix, iy, iu, iv) after smoothing.

As described above, according to the Third Embodiment, even in a case in which history data is insufficient and the like, stability of automatic framing can be improved, and additionally, an image pickup apparatus capable of detailed setting such as prioritization of tracking capability of framing for each area and the like can be realized.

### Fourth Embodiment

In the Fourth Embodiment, when the appearance frequency distribution obtained in the appearance frequency distribution setting processing of step S308 is used for the framing parameter setting at step S309, the appearance frequency distribution is converted into a statistical quantity of any one of an expected value, a variance, and a standard deviation.

That is, the framing control unit of the Fourth Embodiment performs processing for converting the appearance frequency distribution obtained by the appearance frequency distribution acquisition unit into a statistical quantity of any one or more of an expected value, a variance, and a standard deviation. Thereby, in a case in which there is a rapid change in the frequency distribution, or in a case in which history data is insufficient, stability of framing is improved.

When the appearance frequency distribution ƒ(x, y, u, v) has been obtained, an expected value, a variance, and a standard deviation of variables x, y, u, v related to position and velocity can be calculated. When any one of x, y, u, v is represented as a variable a, an expected value E(A) of the variable a, a variance V(A) of the variable a, and a standard deviation D(A) of the variable a can be calculated by using the following Equation (5), Equation (6), and Equation (7), respectively.

E(A)=∫af(x,y,u,v)dxdydudv (5)

V(A)=∫(a−E(A))²ƒ(x,y,u,v)dxdydudv (6)

D(A)=\sqrt{V(A)} (7)

In the Fourth Embodiment, the framing sensitivity coefficient αₛ explained in the First Embodiment is determined, for example, in the following manner by using statistical quantities such as the above-described expected value, the variance, the standard deviation, and the like. It should be noted that here, an example is explained in which the closer the position and the velocity of the subject of interest are to the expected value, the more the scene is regarded as a scene having a high appearance frequency, and framing is performed at a higher sensitivity.

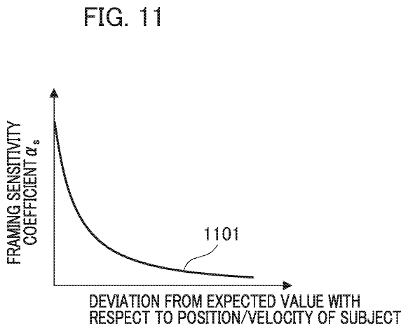

FIG. 11 is a diagram for explaining an example of the framing sensitivity coefficient using statistical quantities in the Fourth Embodiment. In FIG. 11, as an explanatory diagram of the framing sensitivity coefficient using statistical quantities, an example of a relationship between a deviation from the expected value of the position and velocity of the subject of interest, and the framing sensitivity coefficient is shown.

In the Fourth Embodiment, a framing sensitivity coefficient that monotonically decreases with respect to a deviation from the expected value of the target position and the expected value of the target velocity, as shown at 1101 in FIG. 11, is set. Specifically, for the framing sensitivity coefficient αₛ, a framing sensitivity coefficient α_{s,x} for position and a framing sensitivity coefficient α_{s,y} for position, and a framing sensitivity coefficient α_{s,u} for velocity and a framing sensitivity coefficient α_{s,v} for velocity are each calculated, and the framing sensitivity coefficient αₛ is calculated by a weighted linear sum.

The framing sensitivity coefficient α_{s,a} (where a is any of x, y, u, v) shown at 1101 in FIG. 11 can be realized by, for example, a function such as the following Equation (8).

$${α}_{s , a} = exp ( - \frac{\vert a - E ( A ) \vert}{D ( A )} ) \qquad ( 8 )$$

Furthermore, the framing sensitivity coefficient αₛ can be calculated as a weighted linear sum of the framing sensitivity coefficient α_{s,a} by, for example, the following Equation (9).

$${α}_{s} = {\sum }_{a = x , y , u , v} {γ}_{a} {α}_{s , a} \qquad ( 9 )$$

However, γₐ is a weighting coefficient related to position and velocity (x, y, u, v). Accordingly, in order to realize the above in the image pickup apparatus of the Fourth Embodiment, the discrete appearance frequency distribution F(ix, iy, iu, iv) stored in the appearance frequency distribution storage unit 212 is used, and the expected value, the variance, and the standard deviation are calculated based on Equation (5), Equation (6), and Equation (7).

Additionally, the framing sensitivity coefficient αₛ is calculated from the position and the velocity of the subject set by the subject-of-interest setting unit 204 by using Equation (8) and Equation (9), and it suffices to set the framing parameters by a method similar to the method of the First Embodiment.

In this manner, according to the Fourth Embodiment, even in a case in which history data is small and local changes are observed in the appearance frequency distribution, framing parameters for gradual automatic framing can be generated by using the converted statistical quantities.

It should be noted that, although the above-described embodiments have been explained with respect to framing using image information, even in a case in which a three-dimensional sensor is used, and automatic framing is performed based on the position information of a subject and the velocity information of a subject in a three-dimensional space, stabilized control becomes possible.

It should be noted that the appearance frequency distribution of a person as the subject and the appearance frequency distribution of a ball may be held separately, and a weighted sum may be taken within the angle of view. In addition, for example, in the vicinity of a goal, the weighting may be changed so as to prioritize movement of the ball. In addition, at that time, a goal position may be estimated based on movement of a person and movement of a ball, and may be reflected in the appearance frequency distribution.

In addition, for detection of a person and detection of a ball, only a moving bounding box may be detected, and processing may be performed so as to regard the moving bounding box as a player.

In addition, although the above-described embodiments have been explained with respect to ball games in sports, the above-described embodiments are not limited to ball games and are applicable to other sports such as auto racing, keirin, foot racing, and the like, and the subject is not limited to a person, and the above-described embodiments are also applicable to a horse, a dog, and the like. In addition, the above-described embodiments are not limited to sports scenes and are also applicable to indoor events such as a music concert, a wedding ceremony, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image processing apparatus and the like through a network or various storage media. Then, a computer (or a CPU, an MPU, or the like) of the image processing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-083605, filed on May 19, 2025, which is hereby incorporated by reference herein in its entirety.

What is claimed is:

1. An image processing apparatus comprising:
at least one processor; and
a memory coupled to the at least one processor, the memory storing instructions that, when executed by the at least one processor, cause the at least one processor to:
set a subject of interest to which attention should be paid from among subjects detected from an image;
acquire an appearance frequency distribution with respect to at least one of a position of the subject of interest and a velocity of the subject of interest; and
control responsiveness of automatic framing based on the appearance frequency distribution.

2. The image processing apparatus according to claim 1, wherein in the acquisition of the appearance frequency distribution, the appearance frequency distribution is acquired based on a history of at least one of a position of the subject of interest and a velocity of the subject of interest.

3. The image processing apparatus according to claim 1, wherein in the setting of the subject of interest, a position of the subject of interest is set in a two-dimensional space or in a three-dimensional space.

4. The image processing apparatus according to claim 1, wherein in the control of responsiveness of the framing, at least one of an attitude change of an image capturing apparatus for acquiring an image, optical zooming of the image capturing apparatus, and a cutout range of an image of the image capturing apparatus is controlled.

5. The image processing apparatus according to claim 1, wherein in the acquisition of the appearance frequency distribution, for each of the mutually orthogonal coordinate axis directions in a two-dimensional space or in a three-dimensional space, the appearance frequency distribution is set based on a history of a position of the subject and a history of a velocity of the subject.

6. The image processing apparatus according to claim 1, wherein in the control of responsiveness of the framing, filtering processing for smoothing the appearance frequency distribution is performed.

7. The image processing apparatus according to claim 1, wherein in the control of responsiveness of the framing, processing for converting the appearance frequency distribution into a statistical quantity of any one or more of an expected value, a variance, and a standard deviation is performed.

8. The image processing apparatus according to claim 1, wherein in the control of responsiveness of the framing, in a case in which a change in position and attitude of an image capturing apparatus for acquiring an image is detected, processing for transforming the appearance frequency distribution in accordance with the change in the position and attitude is performed.

9. An image processing method comprising:
setting a subject of interest to which attention should be paid from among subjects detected from an image;
acquiring an appearance frequency distribution with respect to at least one of a position of the subject of interest and a velocity of the subject of interest; and
controlling responsiveness of automatic framing based on the appearance frequency distribution.

10. A non-transitory computer-readable storage medium configured to store a computer program comprising instructions for executing the following processes:
setting a subject of interest to which attention should be paid from among subjects detected from an image;
acquiring an appearance frequency distribution with respect to at least one of a position of the subject of interest and a velocity of the subject of interest; and
controlling responsiveness of automatic framing based on the appearance frequency distribution.
